(19) United States
(12) Patent Application Publication
(10) Pub. No.: US 2021/0259228 A1
(43) Pub. Date: Aug. 26, 2021

(54) Multi-Use Fishing Rod Handle and Hand Tool Handle

(71) Applicant: JOSEPH LEE HUTCHINS, JR., BARDSTOWN, KY (US)

(72) Inventor: Joseph Lee Hutchins, JR., Bardstown, KY (US)

(21) Appl. No.: 16/706,486

(22) Filed: Dec. 6, 2019

(51) Int. Cl. A01K 87/08; A01K 87/06; B25G 1/10; B25G 1/06

(52) U.S. Cl. CPC A01K 87/08; B25G 1/06; B25G 1/102; A01K 87/06

(57) ABSTRACT

The present invention identifies a multi-use fishing rod handle, as well as a hand tool handle, that provides a new alignment of the functional elements of the rod handle enabling its use for multiple fishing techniques, including bait, lure, spin and fly casting, enhancing the finger, thumb and palm resting and guiding functions while fishing. The rod handle's functional elements include real seat alignment and attachment, rod connection, and handle extensions, as well as fore or fighting, mid and fly or rear grip areas on the handle. The finger, thumb and palm rests and guides are embodiments as modified forms of the design concepts affecting the mid grip portion of the handle. Similarly, the rod attachments are embodiments that represent alternative means to attach the fishing rod to the handle. The multi-use fishing rod handle continues a general linear alignment with the overall fishing rod while placing an increased emphasis on the hand position and orientation. The finger, thumb and palm resting and guiding functions will have applicability to other hand tools, hand held devices and hand operated controls for machinery and equipment.

### FIELD OF THE INVENTION

Fishing is an activity undertaken by anglers that range from recreation to a source of daily nutrition and subsistence. The present invention pertains to the equipment used in fishing; more specifically, to the improved design of the fishing rod handle placed in the human hand and its connection to the reel and rod as one integrated system. The handle of the present invention improves the flexibility and alignment of the hand with the handle. The design and utility of the present invention also illuminated applications for other hand tools, as well as hand operated controls for machinery and equipment.

In general, the present invention applies to equipment and accessories used by anglers in each type of fishing, bait, lure, spin and fly casting, together with each reel and rod alignment. Further, the present invention pertains to the design and utility of components and methods in making and using the multi-use fishing rod handle as part of a fishing system.

The art of fishing and fishing system assembly are historic and well known. The rod handle is at the core of the system that connects the reel with its line storage, the rod with its line guides and rod tip and bait/lures/flies for presentation to the fish. Most rods are made from materials such as fiber reinforced composites, bamboo, wood and steel, that provide the length, flexibility and strength to catch fish. The rods taper from a handle end with a greater diameter to a tip end with a smaller diameter.

The use and mastery of tools has often arisen as an extension of the human hand, arm and torso, ultimately in a generally straight line for fishing, at 90° in the case of hammering and as a rotation in maneuvering hinged levers. The present invention seeks to improve and enhance the human activity in the use of fishing rods and other hand tools and operating controls.

The present invention seeks to apply knowledge of the human body with recreational and work experience to augment existing designs, thereby improving safety, efficiency, effectiveness and control in operations. Current fishing rod system innovations have concentrated on the rod and its characteristics driving the role and features of the handle and reel/reel seat. The present invention adds a consideration of the handle and its alignment with the human hand, ultimately improving the overall system.

### BACKGROUND OF THE INVENTION

One means of fishing incorporates a fishing rod system comprised of a rod, a reel and a handle, which connects the first two and aligns with the human hand. The handle includes the real seat, connection(s) to the rod and handle extensions selected as the tackle for the individual fishing action chosen. The handle may be gripped in one or more locations with one or two hands, as well as set into a holster or fixed mount. FIG. 1 presents a summary of a typical fishing rod system, together with an introduction to the features of the present invention.

The angler maneuvers and controls the fishing rod through the handle while experiencing the load of casting, the extended fishing line and the catch. The present invention enables the angler to select the fishing technique and rod based on expected conditions and the anticipated catch while improving fishing rod control. Further, the present invention seamlessly connects the handle, including its grip, rest and guide features, reel seat, reel, line storage, rod, line guides and extended line that presents the bait, lure and fly to the fish as a prospective catch.

The current method of constructing fishing rod systems generally includes each component permanently secured with limited finger, thumb and palm rest and guide control points. This traditional method limits an angler to a predisposed selection of rod, reel and technique chosen for the expected conditions and anticipated catch. Success requires the angler to present the bait, lure or fly with a casting technique employing a fishing rod system with optimal qualities across each element individually and collectively.

The present invention starts with the handle as the core of the fishing rod system, where the grip of the human hand provides the power and control to fishing. The current art necessitates a choice in techniques and tackle first, bait, lure, spin or fly, then a selection of an available fishing rod with fixed handle and reel seat. The present invention provides a fishing rod system where the core handle enables the selection of the rod, reel and complementary tackle matched to optimum weight and balance for conditions and the anticipated catch.

### DESCRIPTION OF THE PRIOR ART

Over time, the emphasis in fishing rod design has seen the rod handle take on a form and dimensions more greatly influenced by the fishing rod and less by the human hand holding the fishing rod. Further, the handle design and utility of the present invention will resonate with existing anglers, cross-over athletes and hand tool users that incorporate finger, thumb and palm rests and guides in their respective and customary actions and activities.

A large variety of fishing reels and rods are well-known in the art and practice of fishing. The angler determines the expected catch, then the appropriate tackle and technique. Examples include bait casting, trolling, spin casting and fly fishing as a few examples of the many types available. For each of these categories, additional selections are made for the reel design, line weight, rod length and materials of construction suitable for the fish species and marine setting.

One objective for any angler is to have the right equipment available for the current task, tailored to the individual operating and maneuverability characteristics. Currently, many rods incorporate fixed handles and reel seats, often designed and sold as predisposed sets. In the present invention and potential embodiments, the angler is provided with multiple rod and reel selections for a truly individualized system making use of the preferred fishing rod handle.

### SUMMARY AND GENERAL DESCRIPTION OF THE PRESENT INVENTION

The present invention is directed towards the shape and orientation of a fishing rod handle in the alignment of the key elements of rod attachment, reel seat, grip placement and finger, thumb and palm rests and guides to accommodate multiple fishing techniques with one handle. The finger, thumb and palm rests described for the fishing rod handle may have direct applicability to other hand tool, machinery and equipment motion and control actions in other embodiments of the present invention.

Current practice necessitates the angler to make an a-priori decision on the type of fishing to be undertaken, and pack the necessary tackle and equipment. If conditions change, if the anticipated catch changes, the present invention enables the angler to adapt the fishing rod system by shifting the rod and reel choice around the core handle, while preserving control, power and comfort in the presentation of the bait/lure/fly in these new circumstances.

The objective of the present invention is to enhance the control of the fishing rod system through innovations and enhancements to the handle shape, configuration and alignment of handle elements to more readily compliment the human hand. The present invention will also sustain and improve the tactile sensitivity and operational connectivity to the system elements of reel, reel seat and rod connected to the handle. Further, the present invention provides additional rest and guide positions to improve handling and reduce fatigue during the fishing event. The handle provides flexible grip, reel seat, rod connection and handle extension locations suitable for the tackle and fishing method selected for the anticipated catch and marine conditions.

The present invention is designed to accommodate multiple reel designs. As an example, one embodiment is a reel seat with one end on the longitudinal axis nearest the hand 100 and a second opposite longitudinal end 101 near the more proximate rod connection point 600. Between the two endpoints are the adjustable reel connecting points 102, 103 along the same longitudinal line. Each longitudinal end includes a recessed cavity enabling one fixed end for the reel in the reel seat 100, 101 to complement the adjustable connection 102, 103, respectively.

Further, the present invention multi-use fishing rod handle also accommodates multiple types of fishing rod connections that allow the interchangeability of rod types. The present embodiment includes a conventional compression clamp and cowl fixed to the handle. Other techniques may include friction, bayonet, spring resistance and threaded connections designed to secure the rod to the handle with the suitable end appurtenances on the rod itself.

The descriptive terms above, and other attributes of the present invention will become readily discernible during and following the review of the subsequent more detailed information of the elements, embodiments and appended claims of this nonprovisional patent application. Additional features and benefits of the present invention will become discernible from the combined review of text descriptions with accompanying sketches, drawings, figures and tables attached as representative examples and exemplary embodiments. The enclosed sketches, drawing, figures and tables are included as part of this specification and are illustrative of the elements and overall fishing rod system with the handle at the core.

### BRIEF DESCRIPTION OF THE DRAWINGS, FIGURES AND TABLES

FIG. 1, depicts a schematic overview of the fishing rod system and a representative handle extension that may be added to the otherwise inactive end of the rod handle.

FIG. 2, depicts the Multi-use Handle with the Western Saddle Rest embodiment, in four profile and four cross-section views. The nomenclature for the description of the rests, also referred to as guides, is based on the general appearance of the lateral profile.

FIG. 3, depicts the Multi-use Handle with the Dolphin Rest embodiment, in four profile and four cross-section views.

FIG. 4, depicts the Multi-use Handle with the Branch Rest embodiment, in four profile and four cross-section views.

FIG. 5, depicts the Multi-use Handle with the Whitecap Rest embodiment, in four profile and four cross-section views.

FIG. 6, depicts the Multi-use Handle with the Cape Rest embodiment, in four profile and four cross-section views.

FIG. 7, depicts the schematic contouring that may be utilized in the hand grip as a representative profile view along the longitudinal axis of the handle 200.

FIG. 8 presents Table 1: Schedule of Individual Elements of the Multi-use Fishing Rod Handle, as a ready reference for the individual elements.

FIG. 9 presents Table 2: Schedule of View Lines Contained in the FIGS. 1 through 6, is a reference list of the perspective views found in FIGS. 1 through 6.

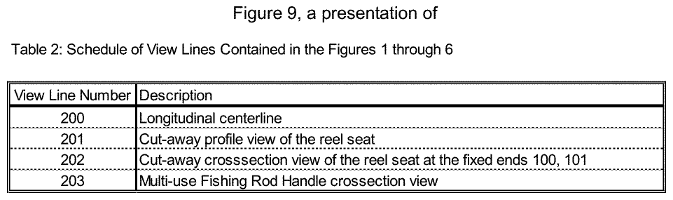

FIG. 10 presents Table 3: Multi-use Handle—Schedule of Drawing Dimensions and Descriptions, in inches, as the dimensions are depicted on FIGS. 2 through 6. The table includes the expected dimension value in addition to anticipated high and low values that may arise in embodiments and personal adaptations of the invention.

FIG. 11 presents Table 3M: Multi-use Handle—Schedule of Drawing Dimensions and Descriptions, in centimeters, as the dimensions are depicted on FIGS. 2 through 6. The table includes the expected dimension value in addition to anticipated high and low values that may arise in embodiments and personal adaptations of the invention.

FIG. 12 presents Table 4: Anticipated Dimensions: Finger, Thumb and Palm Rests and Guides, as depicted in FIGS. 2 through 6, in inches and centimeters.

### DETAILED DESCRIPTION OF THE INVENTION

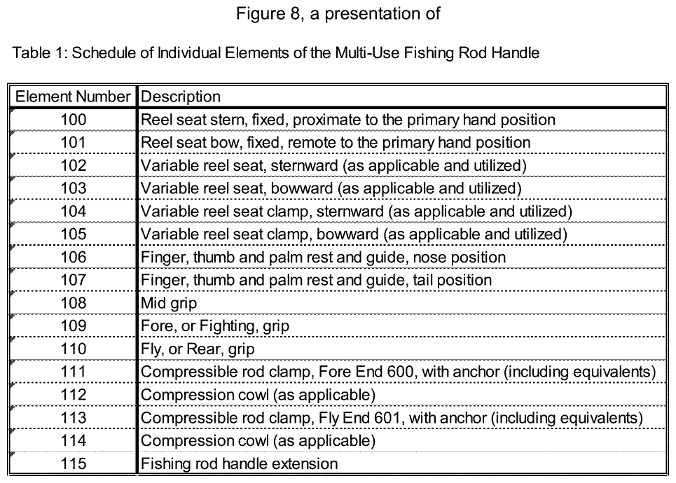

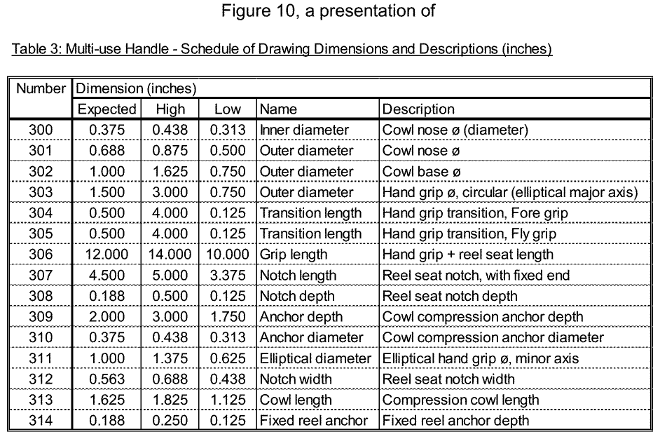

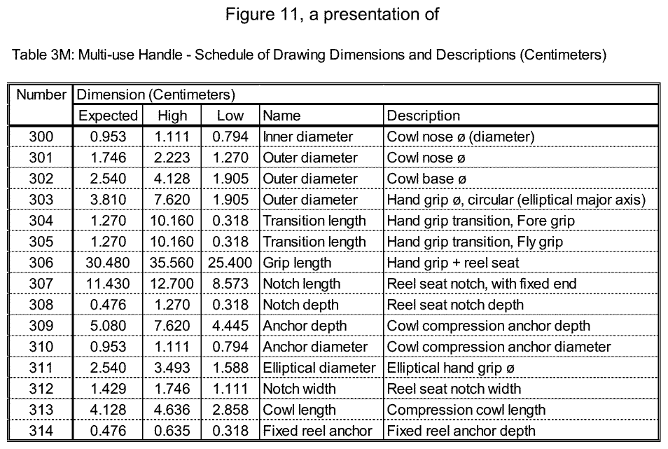

The fishing rod handle positions the hand to enhance the alignment for the human hand, arm, shoulder and torso connection to the fishing rod system, thereby improving the power and control of the casting and fishing activity, while reducing fatigue. The present invention utilizes the focus for the design and utility of the handle on the human hand, complemented by the features of the reel seat and fishing rod connection for each handle orientation in the selected type of fishing and tackle. The schedule of elements comprising the multi-use fishing rod handle system are contained in FIG. 8 Table 1, numbered 100 through 115. The overall handle length 306 is measured before the rod connection attachments and listed in FIG. 10 Table 3 and FIG. 11 Table 3M for inches and centimeters, respectively.

The five depicted finger, thumb and palm rests and guides are embodiments as modified forms of the design and utility concepts affecting the mid grip 108 portion of the handle. In a similar manner, the rod attachment embodiments to the handle may take the form of one or more equivalent embodiments incorporating a compressible clamp, friction clamp, bayonet mount, compression spring and threaded mount as examples of candidate mechanisms.

Conventional practice for reel seats uses a fixed reel closure 100 proximate to the hand for bait, lure and spin casting and fixed reel closure near the remote end 101 of the reel seat for fly fishing. There are also two variable reel seat connections 102, 103 to correspond to each of the fixed reel seat positions.

The design and utility for the multi-use fishing rod handle of the present invention will include an exemplary method of description to accompany the figures and tables. The topics will include five technical areas of the present invention and closes with a background discussion of the terms in the submittal:

Reel seat

Handle grip

Finger, thumb and palm rests and guides

Fishing rod connections

Handle extension

General conditions, terminology and definitions for the present invention

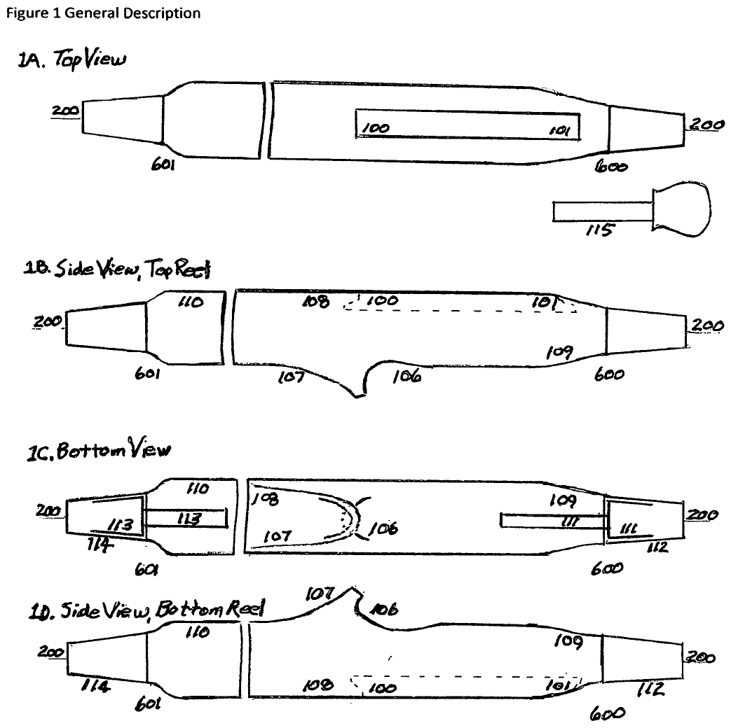

FIG. 1 is a general description of the multi-use fishing rod handle to provide an initial orientation to aid the review prior to the more detailed descriptions to follow. The reel seat, fishing rod connections, grip positions finger, thumb and palm rests and guides and lastly, the handle extension represent the main components of the fishing rod system with the handle at the core.

The multi-use fishing rod handle length 306 is greater than the width 303 to effectively align the human hand with the form and functions of the fishing rod system. In order to more readily describe the features of the present invention, the figures and views of the handle are presented in a landscape format. Four rotated profile views on the long axis 200, first from the top view then rotated 90° in FIGS. 1 through 6, labeled .A, .B, .C, and .D respectively, are shown. The shaded, cross-hatch circle is provided to complement the rotational description.

The multi-use fishing rod handle system 600-601 may be constructed from any desired material that is sufficiently lightweight, strong and durable. The material used should be of a sufficient strength, flexibility and durability to permit an angler to pull upward and laterally on the multi-use fishing rod handle system 600-601 during each casting technique, fishing action and platform without compromising the handle and rod systems 111, 113 integrity. Further, the material used should be sufficiently durable to withstand repeated use and exposure to outdoor elements such as fresh and salt water, dissolved, suspended and transported water-borne elements, cold, heat and sun light, as well as intermittent physical contact incidental to fishing and transportation.

In most applications, the multi-use fishing rod handle system 600-601 is constructed from plastic, fiberglass, graphite, carbon fiber or wood with metal and other materials selected as needed. Many of these materials are readily formed, engineered with properties to be semi-rigid, yet flexible, and non-conductive making them a preferred material of construction. The handle system 600-601 may be constructed wholly or in part from any material that is sufficiently durable, strong and lightweight. In select embodiments, the multi-use fishing rod handle system 600-601 may include internal and surficial reinforcing and load transfer structures to increase the strength and durability of the handle system 600-601, such as webs, lattices, ribs and rods, or any other suitable macro and micro structures.

### Reel Seat

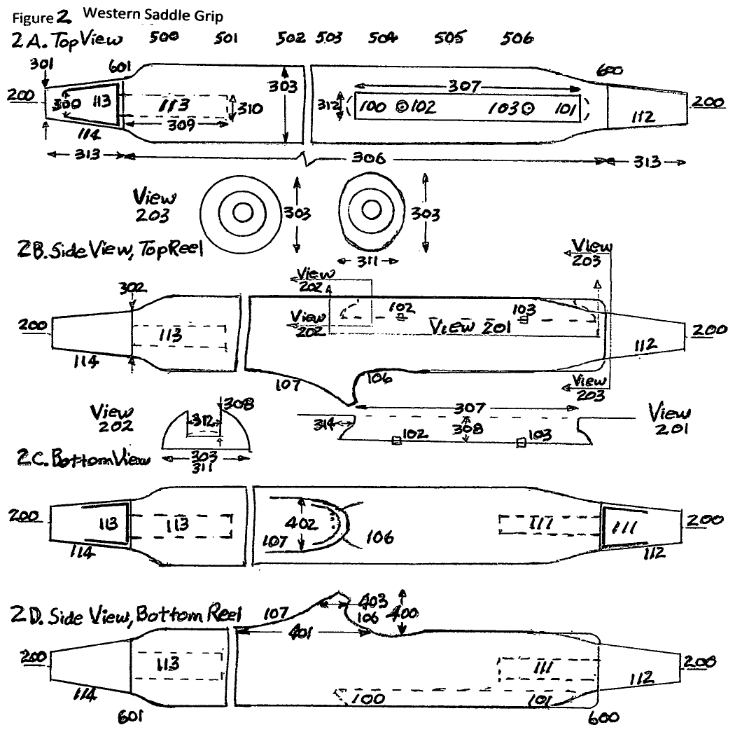

The reel seat anchors the reel to the handle and maintains the fishing line alignment from storage on the reel to the rod guides and rod tip. The fixed clamp 100 proximate to the primary hand position secures one end of the reel while the other end of the reel stand is anchored with the variable reel seat 103. An adjustable and removable clamp 105 accompanies the variable seat position to secure the reel. This reel position is referred to as the bait, lure and spin casting positions for the reel. The fishing line proceeds from the reel across the handle end 600 to the rod guides and rod tip. The casting rod is attached to the handle end 600 with the line guides pointed upward for closed face and transverse guide reels in FIGS. 1B through 6B. The rod is attached to the handle end 600 with the line guides downward for spin casting rods in FIGS. 1D through 6D. Cross section 201 depicts the features along the length of the reel seat while cross section 202 depicts the features across the width of the fixed reel seat in FIGS. 2 through 6.

The fixed clamp 100 has an opening that accepts and holds down the rear foot of the reel stand, a distance measured 314. The fixed clamp may be primarily oval above the flat plane of the reel seat 100 and 101. The reel seat is typically recessed a distance 308 or attached to the handle, generally the reel seat length is several times greater than the width in a suitable shape to receive the range of fishing reel stand types available.

The fixed clamp 101 is remote to the primary hand position and serves as the rearward clamp for the fly fishing reel, while the other end of the fly reel stand is anchored by the variable reel seat 102. An adjustable and removable clamp 104 accompanies the variable seat position to secure the reel. The line stored on the fly reel then proceeds past handle end 601 to the rod guides and tip. The fly fishing rod is attached to handle end 601 with the line guides oriented downward in FIGS. 1D through 6D respectively.

The reel seat chassis between 100 and 101 will have the length 307 and width 312 and constitutes one of the handle's core features—accommodating and securing the reel. The dimensions 307 and 312 will be sufficient and complement the reel stand length and width. The reel seat may be recessed as measured 308 to more closely align the stored line on the reel with the line guides on the attached fishing rod, as well as maintaining the profile, weight and applied forces closer to the handle's longitudinal axis.

### Grip

The term “Grip” refers to the combined effect of the handle surface and shape that accommodates hand placement on the handle. The mid-grip area 108 is the primary hand placement location for the bait, lure and spin casting orientation 600 and for the fly casting orientation of 601. The fore, or fighting, grip 109 area enables the placement of a second hand when necessary for the angler's active efforts to cast and retrieve a catch. The fly, or rear, grip 110 area is the active rod end 601 for fly fishing, in addition to enabling a second hand and an extension for casting from the 600 end of the handle. In the case of a circular handle cross section, dimensions 303 and 311 will be the same.

In a similar manner, for the fly fishing orientation, the fly grip 110 may be complemented by the use of fore grip 109 with a second hand. FIGS. 1 through 6 depict the handle grip with a uniform contour over its length with a taper near ends 600 and 601 to accommodate the transition to the rod connection. The dimensions for the transition length in the grip diameter at the 600 and 601 ends of the handle are 304 and 305 respectively.

The physical profile of the fishing rod handle, along the longitudinal axis, as well as the radial cross section, can be dimensioned and contoured at select distances along the longitudinal axis. Starting from the handle end 601, the various numbered locations and distances from the preceding locations are as follows: 500—one inch, 501—two inches, 502—one inch, 503—two inches, 504—one inch, 505—two inches, 506—one inch (1 inch=2.54 centimeters, 2 inches=5.08 centimeters). Additional locations may be utilized for embodiments with a longer handle as necessary.

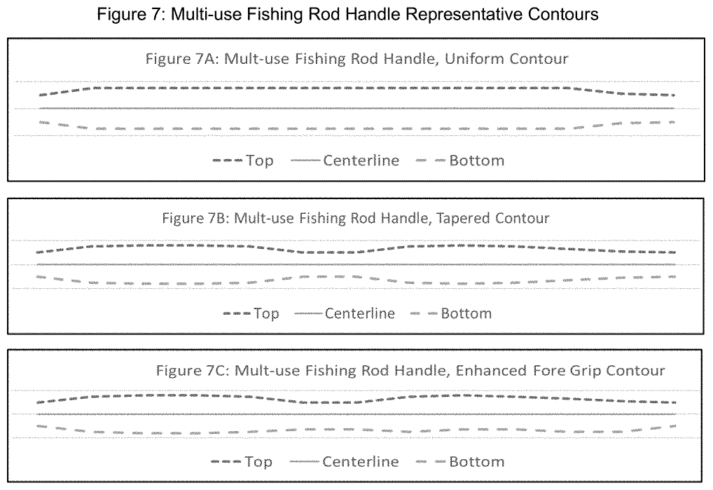

Embodiments to the general contour profile are shown in FIG. 7. FIG. 7A represents the uniform profile shown in FIGS. 1 through 6. FIG. 7B depicts a tapered contour attuned to angler preferences with a smaller diameter cross section near the reel seat 100. FIG. 7C depicts an enhanced fore grip 109 cross section where the angler anticipates greater two-handed fishing. Additionally, the cross section of the handle, views 203 in FIGS. 2 through 6, may be circular, elliptical or generally asymmetric. As seen with the handle profile contour, a great number of embodiments may take place for the handle cross section based on the angler preference.

The elliptical form, as well as some asymmetric forms, provides a cross section modulus along the major axis seen in view 203, and measured by 303, estimated to be greater than the modulus for a circular handle of the same weight and materials of construction. The minor axis, measured by 311 in FIGS. 2 through 6, will remain wide enough to maintain handle integrity and comfortably align with the human hand.

The handle may, with the angler's preference, be cut, formed or molded together in one piece of material, solid and free of voids, remaining seamless with uniform characteristics. The length 306 and width 303 for the handle may be of any angler preferred dimension to accommodate the handle elements while actively fishing.

In anatomical terms, an elliptical handle and fore grip area 109 may be preferred to a circular handle because it physically fills the palm of the hand as a parallel plane through the vertical axis, while it gives a steadier directional grip during the actual casting. The lower and upper front parts of the handle 109 have purposeful elements to accommodate rod action while being able to bend unobstructed upwards and downwards, for example when reeling in large and powerful fish, thereby producing a heavy load or force on the tip of the rod.

### Finger, Thumb and Palm Rests and Guides

Finger, thumb and palm rest and guide members 106-107 are typically situated near the hand proximate end of the reel seat 100, and forms an extension protruding from the lower side of the mid grip 108 area on the opposite diameter to the reel seat. The present invention includes five embodiments of the finger, thumb and palm rests and guides 106-107 as examples of the many embodiments available. The embodiments herein described of the finger, thumb and palm rests and guides have been identified on the basis of an equivalent profile found in nature and human manufactures.

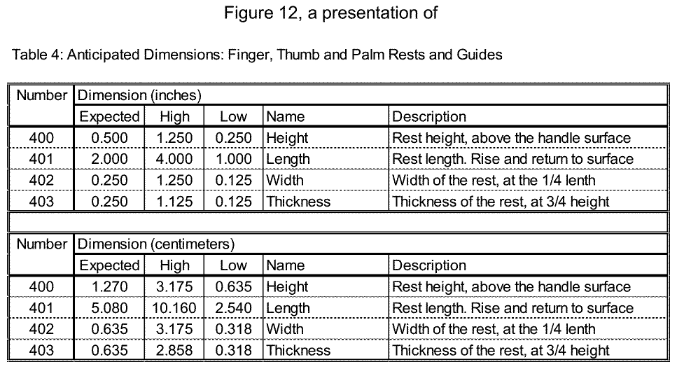

The dominant shape may be round, tapered and elongated, with edges positioned to aid in contact and control. The additional points and planes of contact between the angler's hand and the fishing rod handle system improve power and control while reducing fatigue. The length and width of the rest and guide member 106-107, as shown in FIGS. 1 through 6 are tabulated in Table 4 on FIG. 12, and will be of an appropriate dimension to accommodate the human hand. The primary purpose of the rests and guides 106-107 is to provide the angler greater power and control with less fatigue, tailored to each angler's unique preferences and comfort during the selected orientation of the multi-use handle while performing each act of fishing. FIGS. 2, 3, 4, 5 and 6 demonstrate alternate longitudinal and cross-sectional profiles in height 400, length 401, width 402, and taper 403, with the ranges in dimensions presented in FIG. 12 Table 4, and surface contouring suitable for the fishing action and the hand positioning on the handle by the angler and sport users.

Finger rest member may, if desired, be cut, formed, or molded together into one solid, seamless, and uniform piece, together with the handle.

In FIG. 2, the Western Saddle Rest and Guide embodiment is depicted, the name derived from the general impression remaining from the cutaway profile view of a western saddle. FIG. 2A is a top view, primarily displaying the location of the reel seat. The handle orientation of FIG. 2B portrays the bait and lure casting position with closed and transverse guide reels, with the rest and guide extending downward from the handle 108. This orientation incorporates reel positions 100 and 103 with the rod attachment at the 600 end of the handle. The angler's finger will encircle the rest and guide during each fishing action, readily positioned for either left of right hands. FIG. 2C is a bottom view of the handle, primarily displaying the longitudinal shape of the finger, thumb and palm rest and guide.

The handle orientation of FIG. 2D serves two fishing tackle and action alignments with the Western Saddle Rest and Guide. One alignment serves the spin casting position with the rest and guide extending upward from the handle 108. This orientation incorporates reel positions 100 and 103 with the rod attachment at the 600 end of the handle. The angler's thumb will press upon the more tapered, rearward sloping side 107 of the rest and guide during each fishing action, readily positioned for either the left or the right hand.

The second alignment portrays the fly casting position with the rest and guide extending upward from the handle 108. This alignment incorporates reel seat positions 101 and 102 with the fly reel pointed towards the 601 end of the handle for the fly rod attachment 113. The angler's palm proximate to the wrist will press upon the more tapered side 107 of the rest and guide during each fishing action, readily positioned for either the left or the right hand.

The shaping and contouring of the rest and guide enables a comfortable alignment of each primary point of contact with the remainder of the hand. Each forward 106 and rearward 107 face, as well as the transverse sides and height, will be contoured, tapered and shaped to complement the overall rest and guide while remaining comfortable and effective for the angler.

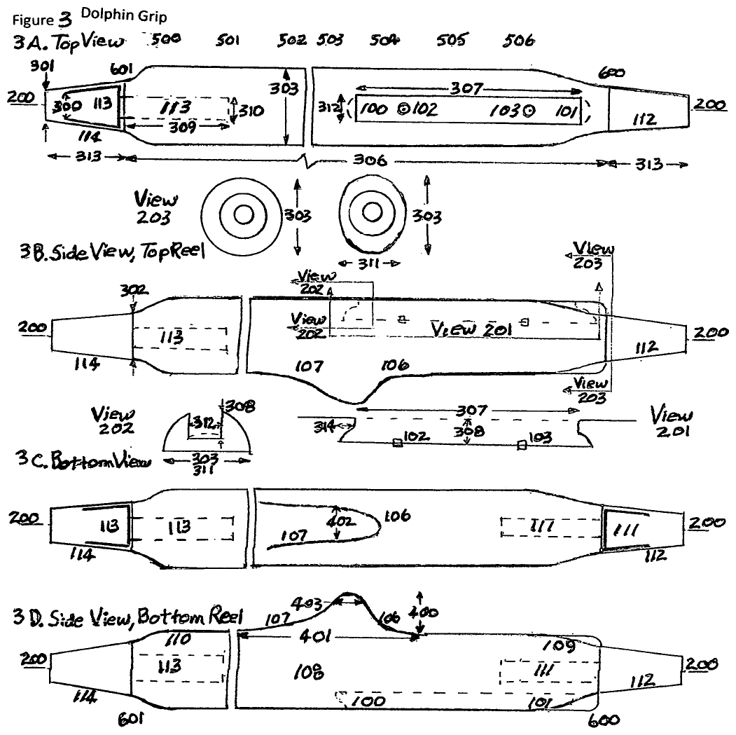

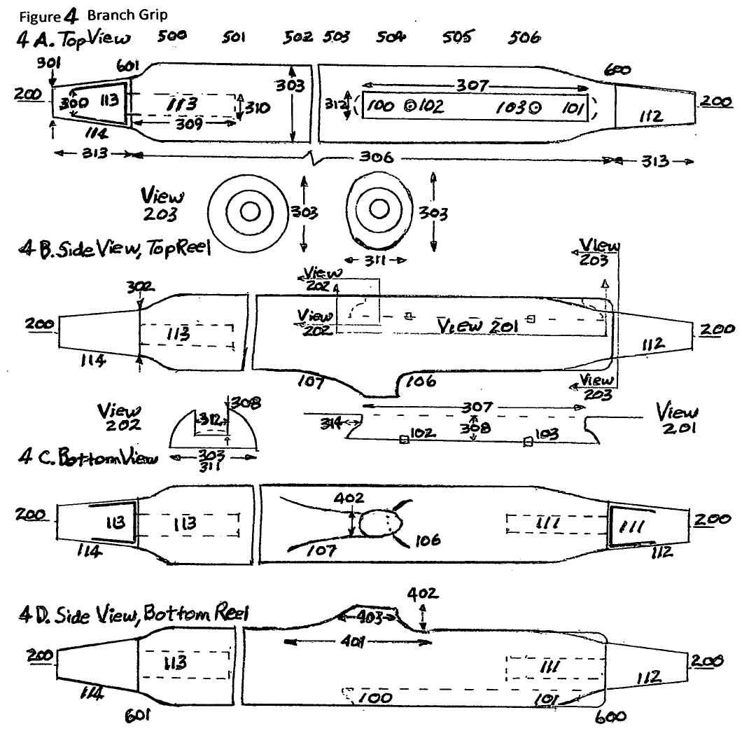

In FIG. 3, the Dolphin Rest and Guide embodiment is depicted as an additional embodiment of the present invention, with the name derived from the profile of a dolphin beginning to emerge from the water. FIG. 3A is a top view, primarily displaying the location of the reel seat. The forward face 106 in view FIG. 3B is more gradual with a less rounded cross section seen in FIG. 3C than seen in FIG. 2C for the Western Saddle type. FIG. 3D also depicts the more gradual contour for the palm rest orientation. The orientation and alignment description for the bait, lure, spin and fly casting discussion of FIG. 2 above are applicable for the Dolphin Rest and Guide of FIG. 3. The discussion remains similar for the subsequent rest and guide descriptions for FIGS. 4 through 6 below.

In FIG. 4, the Branch Rest and Guide embodiment is depicted as an additional embodiment of the present invention, with the name derived from the general orientation of a secondary branch growing away from a more primary branch. FIG. 4A is a top view, primarily displaying the location of the reel seat. The effect is to create a greater separation between the forward 106 and rearward 107 surfaces of the rest and guide, as seen in FIG. 4C, as well as FIGS. 4B and 4D in profile.

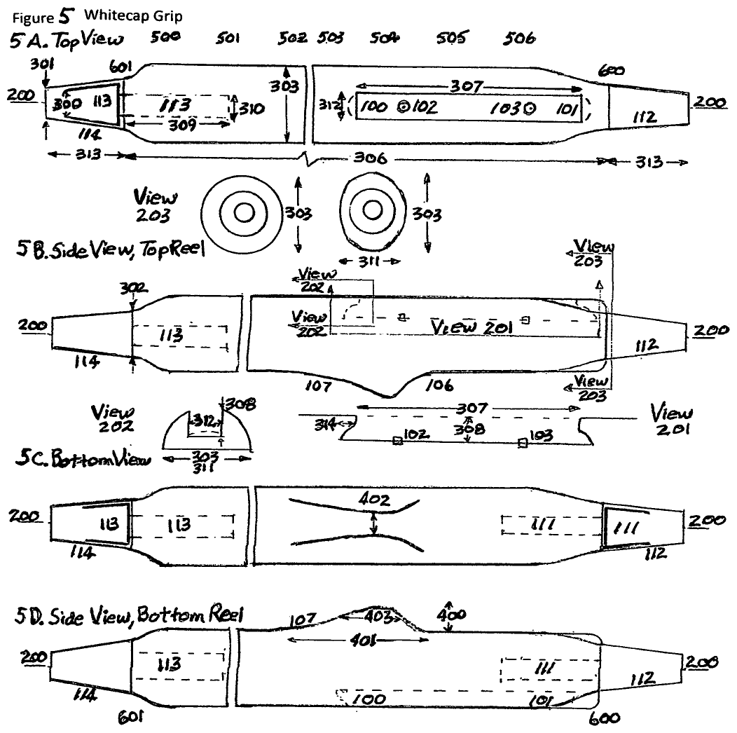

In FIG. 5, the Whitecap Rest and Guide embodiment is depicted as an additional embodiment of the present invention, with the name derived from the general profile image of whitecaps seen by many anglers on rivers, inlets and bays as the wind picks up and the whitecaps emerge. FIG. 5A is a top view, primarily displaying the location of the reel seat. The effect is to create a smooth transition between the forward 106 and rearward 107 faces of the rest and guide, as seen in FIG. 5C, as well as FIGS. 5B and 5D in profile.

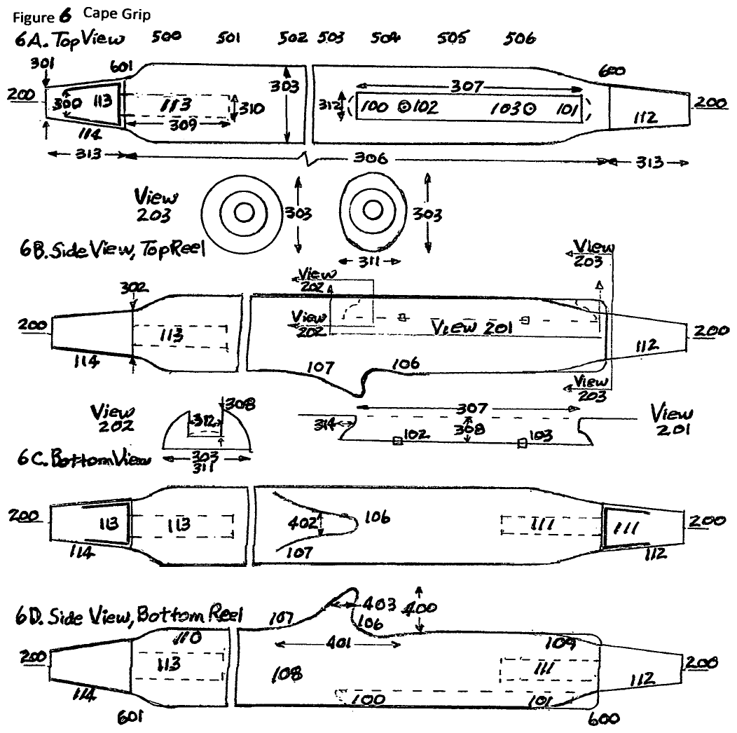

In FIG. 6, the Cape Rest and Guide embodiment is depicted as an additional embodiment of the present invention, with the name derived from the image of a cape extending behind the wearer who may be leaning into the wind. FIG. 6A is a top view, primarily displaying the location of the reel seat. The effect is to create a more vertical forward 106 alignment with a narrower cross section before the flared and tapered cross section of the rearward 107 surface, as seen in FIG. 6C, as well as FIGS. 6B and 6D in profile. One embodiment of the Cape Rest and Guide may be seen as an upgrade to the trigger feature and technology existing with certain fishing rod handles currently in use.

### Fishing Rod Connections

The multi-use fishing rod handle system and embodiments 600-601 incorporates up to two end points of connection for an independent fishing rod with the connecting end of the rod positioned to the handle 111 and 113, where the rod tip end is opposite the connecting end. The multi-use fishing rod handle system and embodiments include a rod anchoring device located on each active handle end 600 and 601. The anchor chassis members 111 and 113 is comprised of attaching component(s) operatively adapted and sized so as to readily attach and secure the rod to the handle. The anticipated and range in depth 309 and diameter 310 measurements of the connections are provided in FIG. 10 Table 3 and FIG. 11 Table 3M. The compression cowls are numbered 112 and 114 respectively. The inner diameter 300 of the compression clamp 113 in FIGS. 10 and 11 are presented in Tables 3 and 3M respectively. The compression cowl 114 outer diameter 301 is depicted in the same tables, along with the base diameter of 302 at the locations 600 and 601, where the length is provided by measurement 313.

Numerous technologies are available for the connecting devices to secure the fishing rod to the multi-use handle. Such technologies may include compressible clamps with a compression cowl, as shown in FIGS. 1 through 6, 111 and 112, 113 and 114, bayonet twist mount, friction sleeves, compression spring mount, and threaded mount are representative of the technologies employed in the fishing and other outdoor industries and hand controlled and operated machinery and equipment. The final choice of the connecting technology may remain with the angler after consideration of the fishing tackle and elements in the expected operating environment.

The handle and cowl can have other shapes. For example, the base trailing end of the cowl can be rectangular and have multi-faceted sides when viewed from above or either side. The shoulders of the cowl can define more gradual curves from the flared end of the handle to the bottom side edges of the cowl. The extended handle 115 with a short tube length may be often employed for the inactive end of the handle 600, 601.

### The Handle Extension

The multi-use fishing rod handle (600, 601) is also able to accommodate a variable dimensioned and removable handle extension 115, a feature that has grown in usage with conventional fishing rod systems, generally as a fixed item. FIG. 1 includes a visual rendering of a representative handle extension 115, including a tubular end and a padded end. The present invention's alternative active ends 600 and 601, each with their respective rod attachment assemblies, provides an alternate use of the inactive handle end remote from the rod attachment.

The handle extension 115 attaches to the handle 600-601 in the same manner as envisioned for the fishing rod 111 and 113. The handle extension 115 then may fulfill one or more roles as an aid to fishing depending upon the angler's tackle and selection of the extension 115 configuration. The image shown in FIG. 1 shows the handle extension 115 with a cushioned end that may serve as a resting point for use by the angler. The other embodiments could include the cushioned end reinforced and extended as a handle grip, as well as the connecting tube elongated, to provide greater leverage and power in casting. Further embodiments could capture fishing rod mounts and anchoring connections.

### GENERAL CONDITIONS, TERMINOLOGY AND DEFINITIONS FOR THE PRESENT INVENTION

Several general conditions, choices in terminology and definitions have arisen in the public domain over time that are suitable and applicable to the nonprovisional patent application process. The following paragraphs are provided as a non-exhaustive description to aid in the review of the enclosed non provisional patent application for the present invention.

As a framework to the description of one or more embodiments of the inventive concepts herein presented in detail, the nonprovisional patent application was prepared with the understanding that the inventive concepts are not limited in their application to the details of construction and the arrangements of the components or steps or methodologies set forth in the description or illustrated in the drawings or summarized in tables. The inventive concepts presented herein are expressive, and representative and exemplary of other embodiments or of being practiced or carried out in various ways. Also, this description or specification was prepared with the understanding that the phraseology and terminology and sketches and figures and drawings and tables employed herein are for the purpose of description and should not be regarded as limiting the inventive concepts claimed herein in any way. The inventive concepts of the present invention and embodiments are readily transferable and adaptable to other situations, conditions, technologies and industries, including recreational.

As used herein, the terms “comprises,” “comprising,” “includes,” “including,” “has,” “having,” or any other variation thereof, are intended to cover a non-exclusive inclusion and listing. As an example, a process, method, article, or apparatus that comprises a list of elements is not necessarily limited to only those elements but may include other elements not expressly listed yet found in the current, as well as future, embodiments.

As a description of the meaning for words and terms, unless expressly stated to the contrary, “or” refers to an inclusive “or” and not to an exclusive “or”. The use of the “a” or “an” are employed to describe elements and components of the embodiments herein. This is done merely for convenience and to give a general sense of the inventive concepts. This description should be read to include one or at least one and the singular also deemed to include the plural unless it is obvious that it is meant otherwise.

The detailed description in text, figures, sketches, drawings and tables of one and more embodiments of the inventive concepts underlying the present invention, numerous descriptions and more specific details are set forth in order to provide a more thorough understanding of the inventive concepts that underly the design and utility of the multi-use fishing rod handle. However, it will be apparent to one of ordinary skill in the art that the inventive concepts within the disclosure may be practiced without these specific details while relying on general details. In other instances, well-known features have not been described in detail to mitigate unnecessarily complicating the instant disclosure.

For the purpose of promoting an understanding of the principles of the present invention, references are made to the embodiments illustrated in the drawings, and specific language will be used to describe the same wherever possible. However, it is to be understood that the disclosed embodiments are merely exemplary of the invention that may be further embodied in various and alternative forms. The figures are generally to scale where possible, with generally recognized limitations that may arise in copying and electronic transmission, and some features may be exaggerated or minimized to show details of particular components. Figures to scale include a reference scale where applicable.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings and figures and sketches and tables included herein.

Finally, descriptions provided in the current nonprovisional patent application, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

The present invention incorporates the methods of making and using any of the disclosed and claimed multi-use fishing rod and hand tool handles including, but not limited to, the handles, reel seats suitable for use with the handles, and rod attachment devices 111, 113, and any hand tool and hand controlled machinery and equipment, as well as any adaptation of the present invention. Further, any of the above-described components may be formed using conventional and evolving manufacturing techniques and processes, including automated control, robotic manufacturing and three-dimensional printing.

Any of the above-described components may be manufactured from any type of suitable material. Suitable materials may, if desired, be of a homogeneous composition, a multi-component composition of varying materials and orientation, including composites and laminates. Suitable materials may, if desired, be semi-rigid or have varying degrees of stiffness engineered along its longitudinal length. Suitable materials may include, but are not limited to, any plastic, metal (e.g., aluminum, stainless steel, etc.), wood, bamboo, graphite, fiberglass, ceramic, or any combination of one or more of these materials.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope and inventive concepts. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the claims and inventive concepts described herein.

1. The present invention is a multi-use fishing rod handle, providing alternate orientations to enable bait, lure, spin and fly casting, while providing finger, thumb and palm rests and guides consistent with each orientation. The rod handle is composed of a reel seat, the fore, or fighting, mid and fly, or rear, grip sections and attachment points for connecting fishing rods and handle extensions appropriate to the desired fishing action. Several different techniques exist for attaching and connecting the reel to the reel seat and the rods to the handle in conventional as well as innovative approaches, often influenced by the materials of construction, available equipment and fishing practices.

2. The fishing rod handle of claim 1 has the end nearest the reel seat designated as the casting end “600”, with the fore, or fighting end, and the end furthest from the reel seat as the fly, or rear, end “601”. The casting rods are attached at the “600” end, with the fishing line guides oriented to accommodate the bait and spin casting reels, respectively, as affixed to the reel seat. The fly rod is attached at the “601” end with the line guides oriented to the downward position of the fly reel and reel seat.

3. The fishing rod handle of claim 2 may have the fishing rods attached to the “600” and “601” ends of the handle via a cowl compression attachment fixed to the handle via a drilled and tapped anchor screw, or discrete mounts installed within the handle operating via bayonet, friction, spring loaded and threaded anchoring members, or equivalents. Individual handle elements will be dimensioned to accommodate individual attachments, including the reel stand thickness and lengths, rod diameters and connecting lengths, while preserving the operational integrity of the connected elements.

4. The fishing rod handle of claim 1 may have the reel seat with a fixed notch established at both longitudinal ends, elements 100 and 101, to anchor one end of the reel stand, with the other end of the reel stand held in place by a moveable and adjustable anchoring screw, elements 102 and 103, with cover piece, elements 104 and 105, to accommodate the raised cross-section of the reel's stand. The bait and spin casting reels will be located towards the middle grip 108 end of the reel seat, more proximate to the primary hand position. The fly casting reels will be located at the reel seat end nearest the fighting grip 109, more remote to the primary hand position.

5. The fishing rod handle of claim 1 will have finger, thumb and palm rests and guides 106, 107 aligned towards the mid-grip 108 and on the opposing diameter of the handle from the reel seat, suitable for the orientation of the rod handle as the handle supports bait, spin and fly fishing casting actions.

6. The finger, thumb and palm rests and guides of claim 5, may demonstrate alternate longitudinal and cross-sectional profiles in height 400, length 401, width 402, taper 403 and surface contouring suitable for the fishing action and the hand positioning on the handle by the angler and sport users.

7. The finger, thumb and palm rests and guides of claim 5 serve to emphasize the design influence for an alignment with the user's hand, thereby enhancing power and control of the manual operation with less fatigue, while returning the long slender fishing rod influence to the rod design.

8. The rod handle cross-section may vary along the length of the rod handle of claim 1 in accordance with the anticipated hand position and actual fishing demands. Further, the cross section may be circular in nature, elliptical, oval, a hybrid, and tapered, as well as contoured to accommodate individual preferences. The cross-section may shift along the length of the handle in anticipation of shear forces, bending moments and section modulus of the handle, as well as the unique attributes with each human hand.

9. The generally cylindrical shape and surfaces of the rod handle of claim 8 are anticipated to include embodiments modified to accommodate the palm of the hand, fingers and thumb along the grip for each of the fishing positions contemplated.

10. The generally cylindrical shape of the fishing rod handle of claim 8 has a longitudinal axis that may form an angle of intercept with the longitudinal centerline of the fishing rod from 0° to 15°. The point of interception between the longitudinal centerlines of the handle and the rod may be found along the handle centerline consistent with the control, agility and ease of use in fishing.

11. The center of the point of attachment for the fishing rod in claim 8, through which passes the longitudinal centerline of the fishing rod, may be offset above, below or laterally from the longitudinal centerline of the handle consistent with the control, agility and ease of use in fishing.

12. The longitudinal centerline axis of the reel seat 100, 101 in claim 8 may lie parallel to the longitudinal centerline of the handle and of the rod. The reel seat longitudinal centerline axis may also be modified to intersect either the fishing handle or the fishing rod, or both, at an angle between 0° to 5°.

13. The surfaces of the fishing rod handle in claim 9 may be uniform or may vary across the handle, including ribbed and tapered contouring, while accommodating the finger, thumb and palm rests and guides, as well as the reel seat and fishing rod connections and handle extension.

14. The bait, lure, spin and fly casting rod attachments may have independent and different alignments with the handle's longitudinal centerline.

15. The finger, thumb and palm rests and guides of claim 6, including the alternative orientational alignments, may also be suitable for other hand tool and hand operated controls for machinery and equipment, where handles may be used in one or more operating directions and purposes, e.g., a carpenter's hammer with the nail driving and claw wedge functions, as well as rotational levers used to manage machinery and equipment.
